(19) United States
(12) Patent Application Publication
(10) Pub. No.: US 2012/0284702 A1
(43) Pub. Date: Nov. 8, 2012

(54) BINDING APPLICATIONS TO DEVICE CAPABILITIES

(75) Inventors: Narayanan Ganapathy, Redmond, WA (US); Max G. Morris, Seattle, WA (US); Paul Sliwowicz, Seattle, WA (US); Darren R. Davis, Woodinville, WA (US); George Evangelos Roussos, Seattle, WA (US)

(73) Assignee: MICROSOFT CORPORATION, Redmond, WA (US)

(21) Appl. No.: 13/099,260

(22) Filed: May 2, 2011

(51) Int. Cl. G06F 21/00; G06F 9/445

(52) U.S. Cl. 717/174; 726/17

(57) ABSTRACT

Installation data associated with a hardware device is obtained (e.g., at the time the device is installed on a computing device). Identifiers of applications that are allowed to access a capability of the hardware device are identified from the installation data and stored in a device permissions record as being allowed to access the capability of the hardware device. Subsequently, a request to access the capability of the hardware device is received from an application. A check is made as to whether the application is identified in a device permissions record as being allowed to access the capability of the hardware device. The application is allowed to access the capability of the hardware device if the device permissions record indicates the application is allowed to access the capability of the hardware device, and otherwise the request from the application is denied.

### BACKGROUND

Computers typically allow programs to access various hardware devices, such as storage devices, cameras, microphones, printers, and so forth. While having such hardware devices available allows programs to provide functionality that users desire, controlling access to such hardware devices by different programs can be problematic. One such problem is that users may be prompted for their approval in order for a program to access a hardware device, but such prompting can be difficult to explain to users. For example, when prompting a user for approval, it can be difficult to explain to the user exactly what the access to a particular hardware device is and what the implications of allowing the access are. This can result in a confusing user experience, reducing the user friendliness of the computer.

In addition users, where supported, may add new hardware devices to their existing computer configuration. The addition of these new hardware devices complicates traditional approaches for allowing programs to access hardware devices because it is oftentimes assumed that the list of known possible hardware devices and their capabilities is always available.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a request to access a capability of a hardware device installed on a computing device is received from an application. A check is made, by the computing device, as to whether the application is identified in a device permissions record as being allowed to access the capability of the hardware device. The application is allowed to access the capability of the hardware device if the device permissions record indicates the application is allowed to access the capability of the hardware device, and otherwise the request from the application is denied.

In accordance with one or more aspects, installation data associated with a hardware device is obtained. An identifier of an application that is allowed to access a capability of the hardware device is identified from the installation data. The identifier of the application is stored in a device permissions record as being allowed to access the capability of the hardware device without further user consent.

### BRIEF DESCRIPTION OF THE DRAWINGS

The same numbers are used throughout the drawings to reference like features.

FIG. 1 is a block diagram illustrating an example computing device implementing the binding applications to device capabilities in accordance with one or more embodiments.

FIG. 2 is a block diagram illustrating an example system implementing the binding applications to device capabilities in accordance with one or more embodiments.

FIG. 3 is a flowchart illustrating an example process for changing a device permissions record in accordance with one or more embodiments.

FIG. 4 is a flowchart illustrating an example process for responding to requests to access a capability of a hardware device in accordance with one or more embodiments.

FIG. 5 illustrates an example computing device that can be configured to implement the binding applications to device capabilities in accordance with one or more embodiments.

### DETAILED DESCRIPTION

Binding applications to device capabilities is discussed herein. A computing device can have different hardware devices installed thereon, and these different hardware devices can have various capabilities. A device permissions record is maintained that indicates which applications are allowed to access which capabilities of which hardware devices of the computing device. This device permissions record is dynamic, changing over time in response to various user inputs indicating which applications are allowed to access which capabilities of which hardware devices of the computing device. While some embodiments have a fixed set of device permission records, other embodiments support an extensible set of device permissions records enabling new records to be created as new, previously unknown hardware devices are added to the computing device. An application running on the computing device can request access to a particular capability of a hardware device installed on that computing device. In response to such a request, a device broker checks the device permissions record to determine whether the application is allowed to access that particular capability of that particular hardware device. The application is allowed to access that particular capability of that particular hardware device if the device permissions record indicates the application is allowed to do so; otherwise, the application is not allowed to access that hardware device.

References are made herein to symmetric key cryptography, public key cryptography and public/private key pairs. Although such key cryptography is well-known to those skilled in the art, a brief overview of such cryptography is included here to assist the reader. In public key cryptography, an entity (such as a user, hardware or software component, a device, a domain, and so forth) has associated with it a public/private key pair. The public key can be made publicly available, but the entity keeps the private key a secret. Without the private key it is computationally very difficult to decrypt data that is encrypted using the public key. So, data can be encrypted by any entity with the public key and only decrypted by an entity with the corresponding private key. Additionally, a digital signature for data can be generated by using the data and the private key. Without the private key it is computationally very difficult to create a signature that can be verified using the public key. Any entity with the public key can use the public key to verify the digital signature by executing a suitable digital signature verification algorithm on the public key, the signature, and the data that was signed.

In symmetric key cryptography, on the other hand, a shared key (also referred to as a symmetric key) is known by and kept secret by the two entities. Any entity having the shared key is typically able to decrypt data encrypted with that shared key. Without the shared key it is computationally very difficult to decrypt data that is encrypted with the shared key. So, if two entities both know the shared key, each can encrypt data that can be decrypted by the other, but other entities cannot decrypt the data if the other entities do not know the shared key. Similarly, an entity with a shared key can encrypt data that can be decrypted by that same entity, but other entities cannot decrypt the data if the other entities do not know the shared key. Additionally, digital signatures can be generated based on symmetric key cryptography, such as using a keyed-hash message authentication code mechanism. Any entity with the shared key can generate and verify the digital signature. For example, a trusted third party can generate a symmetric key based on an identity of a particular entity, and then can both generate and verify digital signatures for that particular entity (e.g., by encrypting or decrypting the data using the symmetric key).

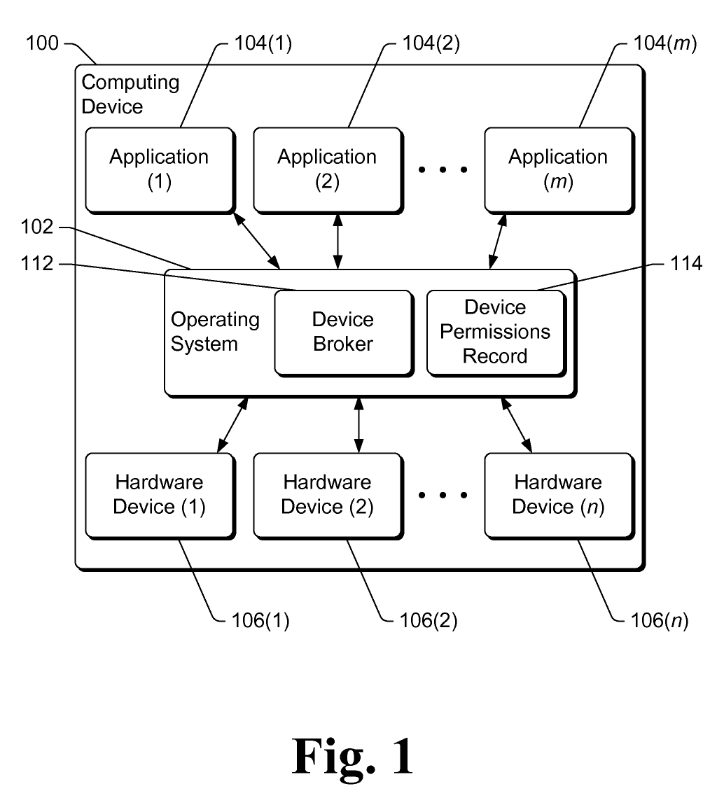

FIG. 1 is a block diagram illustrating an example computing device 100 implementing the binding applications to device capabilities in accordance with one or more embodiments. Computing device 100 can be a variety of different types of devices. For example, computing device 100 can be a desktop computer, a netbook or laptop computer, a notepad or tablet computer, a mobile station, an entertainment appliance, a set-top box communicatively coupled to a display device, a television or other display device, a cellular or other wireless phone, a game console, an automotive computer, and so forth.

Computing device 100 includes an operating system 102, one or more (m) applications 104(1), . . . , 104(m), and one or more hardware devices 106(1), . . . , 106(n). Applications 104 can each be any of a variety of different types of applications, such as games or other entertainment applications, utility applications, productivity applications (e.g., word processing or spreadsheet applications), reference applications, communication applications, and so forth. Applications 104 can be obtained by computing device 100 from local sources (e.g., installed from a local disc or flash memory device), and/or from remote sources (e.g., obtained from another device via a network such as the Internet, a cellular or other wireless network, etc.).

Hardware devices 106 can each be any of a variety of different devices or components that are accessible to operating system 102. For example, a hardware device 106 can be a camera, a microphone, a printer, a storage device (e.g., Flash memory, a subscriber identity module (SIM) card, etc.), a mobile broadband chipset or card, and so forth. A hardware device 106 can be included as part of computing device 100 (e.g., included in the same housing as a processor and memory of computing device 100) and/or be a separate device coupled to computing device 100 (e.g., via a wired or wireless connection). A hardware device 106 is installed on computing device 100 by physically adding the new hardware device to the same physical enclosure as computing device 100, or by otherwise coupling (e.g., using a wired and/or wireless connection) the new hardware device to computing device 100, and having associated software and/or firmware installed (if not previously installed) on computing device 100. This associated software and/or firmware is also referred to as a device driver, which understands how to communicate with the associated hardware device and allows other applications, components, or modules in computing device 100 to access the associated hardware device. The exact functionality provided by the device driver may be known or unknown to operating system 102 at the time computing device 100 was created.

Operating system 102 manages applications 104 running on computing device 100, including managing access to hardware devices 106 by applications 104. Operating system 102 includes a device broker 112 and device permissions record 114. In order to access a hardware device 106, an application 104 requests access to that hardware device 106 from operating system 102. Device broker 112 checks device permissions record 114 to determine whether the requesting application 104 is allowed to access that hardware device 106. If device permissions record 114 indicates that the requesting application 104 is allowed to access that hardware device 106, then device broker 112 allows the requesting application 104 to access that hardware device 106. However, if device permissions record 114 indicates that the requesting application 104 is not allowed to access that hardware device 106, then device broker 112 prevents (or otherwise disallows) the requesting application 104 from accessing that hardware device 106.

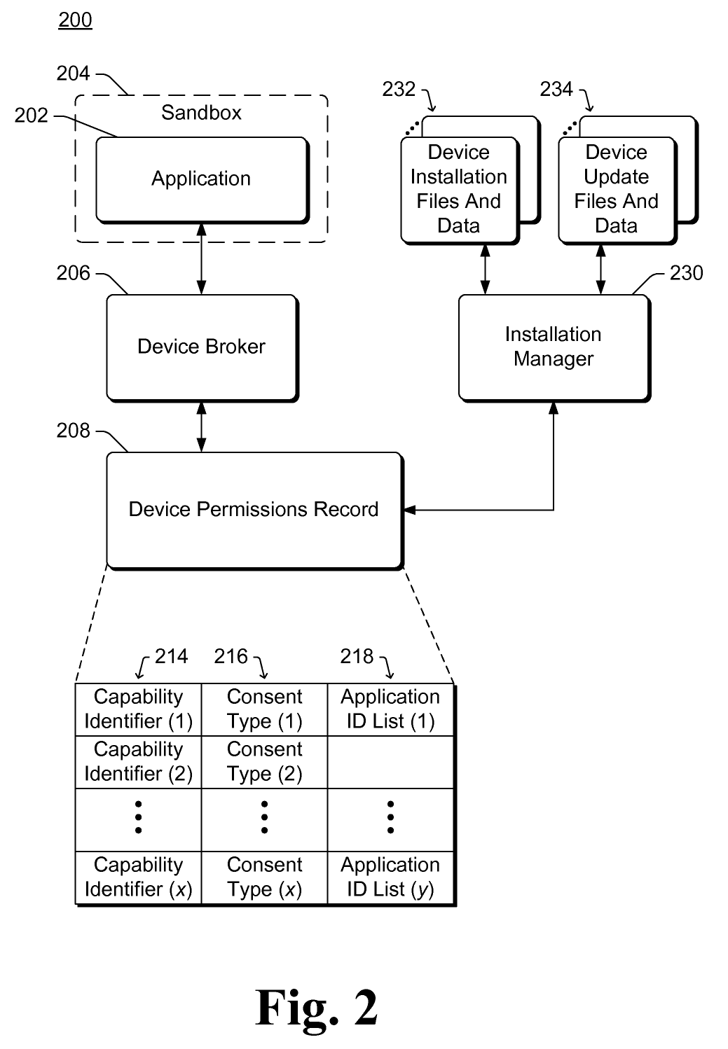

FIG. 2 is a block diagram illustrating an example system 200 implementing the binding applications to device capabilities in accordance with one or more embodiments. System 200 is implemented on a computing device, such as computing device 100 of FIG. 1. System 200 includes an application 202, which can be an application 104 of FIG. 1. Application 202 can be executed in a manner in which the ability of application 202 to access devices and/or other resources of system 200 (e.g., memory, other applications, etc.) is restricted. The operating system (or alternatively other software or firmware) of the computing device allows application 202 to access memory of the computing device that has been allocated or otherwise made available to application 202, but prevents application 202 from accessing other memory of and/or other applications executing on the computing device. This protects other applications executing on the computing device from being interfered with by application 202, as well as protects application 202 from being interfered with by other applications executing on the computing device. In one or more embodiments, application 202 is executed in a restricted manner by executing application 202 in a sandbox (shown with a dashed line as sandbox 204). Although a single application 202 is illustrated in system 200, it should be noted that multiple applications can be executing in system 200 concurrently (each application typically being executed in its own sandbox).

Hardware devices installed on the computing device implementing system 200 can include various capabilities, one or more of which can be grouped together into a collection or class of capabilities. The capabilities of a hardware device refer to the functionality and/or operations provided or otherwise supported or allowed by the hardware device. The particular capabilities of a hardware device and the manner in which they are grouped together can be defined by a designer or vendor of the hardware device, or alternatively by another component or entity (e.g., by a designer or vendor of the operating system on the computing device). For example, a printer device may include print capabilities (allowing applications to send data to the printer for printing) and management capabilities (allowing applications to recalibrate print heads, obtain ink or toner levels, obtain statistics regarding printing, etc.). By way of another example, a mobile broadband device may include communication capabilities (allowing applications to send and/or receive data via a mobile broadband connection, such as text messages, multimedia messages, Web pages, etc.), provisioning capabilities (allowing applications to provision or set up the mobile broadband device for use on a particular network), and management capabilities (allowing applications to adjust configuration settings for use with a particular network, obtain information regarding usage (e.g., amounts of data sent and/or received) over a particular network, etc.), and so forth. The functionality of hardware devices coupled to computing device implementing system 200 need not be (but alternatively can be) known to the operating system or other components of the system other than application 202.

In order to access a particular class of capabilities of a hardware device, application 202 submits a request to device broker 206 to access the desired capabilities. Device broker 206 can be, for example, a device broker 112 of FIG. 1. Application 202 can submit the request to device broker 206 in a variety of different manners. In one or more embodiments, application 202 submits a request to open or create a handle to (or other identifier of) the desired capabilities of the hardware device that application 202 can then use to access those capabilities. The request can be, for example, a request to open a handle to a device interface class. In response to the request, device broker 206 checks device permissions record 208 (which can be a device permissions record 114 of FIG. 1) to determine whether application 202 is allowed to access the requested capabilities. Device broker 206 returns the requested handle to (or other identifier of) the requested capabilities only if device permissions record 208 indicates that application 202 is allowed to access the requested capabilities. This handle to (or other identifier of) the requested capabilities can take various forms, such as an identification of one or more device drivers (e.g., software or firmware) associated with the hardware device, an identification of one or more application programming interfaces (APIs) of one or more device drivers associated with the hardware device, and so forth. In one or more embodiments, device broker 206 (or at least the portion of device broker 206 that checks device permissions record 208) is implemented as a trusted component of system 200 (such as part of a trusted core or other trusted part of an operating system) to prevent application 202 from tampering with device broker 206 checking device permissions record 208.

Device permissions record 208 includes capability identifiers 214, and associated consent types 216. Each collection or class of capabilities of a hardware device installed on the computing device including system 200 has a corresponding capability identifier 214. Each capability identifier 214 has an associated consent type 216 that indicates what type of consent is needed, if any, in order for an application to access the class of capabilities identified by the capability identifier 214. Thus, different classes of capabilities for the same hardware device can have different associated consent types, indicating different types of consent needed in order for an application to access those different classes of capabilities. Depending on the type of consent that is needed in order for an application to access the class of capabilities identified by the capability identifier 214, the capability identifier may also have an associated application identifier (ID) list 218. Each application ID list 218 is a list of one or more application identifiers that are allowed to access the capabilities identified by the associated capability identifier 214.

In one or more embodiments, each capability identifier 214 is a device interface class that identifies a particular class or collection of capabilities of a particular type of hardware device. For example, a capability identifier 214 can be an identifier of image capture capabilities of a camera type of device, an identifier of camera configuration capabilities of a camera type of device, an identifier of communication capabilities of a mobile broadband type of device, an identifier of provisioning capabilities of a mobile broadband type of device, and so forth. Multiple different hardware devices of the same type (e.g., multiple different cameras) can be included as part of the same device interface class. Device interface classes can be defined by or as part of the operating system (e.g., operating system 102 of FIG. 1) and/or by other entities (e.g., hardware device designers or vendors).

During operation of system 200, a device driver associated with a particular hardware device installed on the computing device registers, with the operating system of the computing device, an instance of the device interface class for that particular hardware device. The operating system associates that instance of the device interface class with that particular hardware device, and maintains an indication of how an application (such as application 202) can access the capabilities of that instance. In one or more embodiments, this indication is a handle for the instance of the device. Alternatively, this indication can be implemented in other manners, such as a pointer, a link, or other identifier of the capabilities. It should be noted that although handles are discussed herein, other indications of how an application can access the capabilities of an instance can be used in an analogous manner to handles. In order to access the capabilities of that particular hardware device, application 202 requests, from device broker 206, the handle for that instance. Device broker 206 returns the handle for an instance of a particular device interface class only if device permissions record 208 indicates that application 202 is allowed to access that particular device interface class.

Alternatively, rather than device interface classes, capability identifiers 214 can identify hardware devices or types of hardware devices in other manners. In one or more embodiments, rather than device interface classes other categories or groupings of hardware devices are maintained, and each such category or grouping is associated with a consent type 216. These categories or groupings can be defined in different manners, such as collections of devices provided by the same distributor or manufactured by the same vendor, collections of devices that have been evaluated and approved by a particular company, group, or other entity, and so forth. In other embodiments, rather than device interface classes individual hardware devices can each be associated with consent types 216. The individual hardware devices can be identified in different manners, such as by model number or other identifier assigned by the distributor or vendor of the hardware, by an identifier of a device driver associated with the hardware device, and so forth.

Thus, by way of example, a capability identifier 214 can be a hardware instance ID that identifies an instance of a particular device interface class for a particular hardware device. By way of another example, a capability identifier 214 can be a model ID for the particular hardware device, the model ID identifying various characteristics of the particular hardware device (e.g., a vendor's manufacture identifier, a class identifier, a revision identifier, combinations thereof, etc.).

Each consent type 216 indicates what type of consent is needed, if any, in order for an application to access the class of capabilities identified by the associated capability identifier 214. Various different types of consent can be identified in consent type 216. In one or more embodiments, each consent type 216 is one or more of allow, deny, prompt, or privileged. The allow consent type indicates that access to the associated capabilities is allowed (regardless of the application requesting access to a hardware device). The deny consent type indicates that access to the associated capabilities is not allowed (regardless of the application requesting access to a hardware device). The prompt consent type indicates that a user of the computing device implementing system 200 is to be prompted for approval for the application to access the associated capabilities. The privileged consent type indicates that access to the associated capabilities is allowed only to privileged applications.

If the consent type 216 indicated in a particular capability identifier 214 is the privileged consent type, then device permissions record 208 also includes an application ID list 218 associated with the capability identifier 214. If the consent type 216 indicated in a particular capability identifier 214 is other than the privileged consent type (e.g., is the allow, deny, or prompt consent type), then no application ID list 218 associated with that particular capability identifier 214 need be included in device permissions record 208. Each application ID list 218 is a list of one or more application identifiers that are allowed or permitted to access the capabilities identified by the associated capability identifier 214 (e.g., the privileged applications). If the consent type for a capability is the privileged consent type and application 202 is not included in the application ID list associated with the capability identifier 214 of the capabilities of the hardware device for which application 202 requests access, then application 202 is denied access to those capabilities of the hardware device. Alternatively, if the consent type for a capability is privileged, an indication of the privileged consent type need not be included as consent type 216 associated with the capability identifier 214. Rather, the existence of an application ID list 218 associated with the capability identifier 214 can inherently indicate that the consent type associated with the capability identifier 214 is the privileged consent type.

This association of capabilities of hardware devices (or types of hardware devices) and application identifiers that are allowed to access those capabilities is also referred to as binding applications to the hardware devices. If an identifier of application 202 is included in the application ID list associated with a capability identifier 214, then application 202 is bound to the capabilities identified by the associated capability identifier 214. However, if an identifier of application 202 is not included in the application ID list associated with a capability identifier 214, then application 202 is not bound to the capabilities identified by the associated capability identifier 214.

An application identifier for application 202 can be generated in a variety of different manners. In one or more embodiments, an application identifier for application 202 is generated by applying a cryptographic hash function to application 202 and/or metadata of application 202 to generate a hash value. Any of a variety of different cryptographic hash functions can be used, such as SHA-1 (Secure Hash Algorithm 1) or SHA-2, Whirlpool, Tiger, FSB (Fast Syndrome-based hash functions), and so forth. Device broker 206, or another component or module that is trusted by device broker 206, can generate the hash value for application 202. The hash value for application 202 can be generated at different times, such as the hash value for application 202 being previously generated and provided to device broker 206 (e.g., generated when application 202 is installed on a computing device including system 200, when application 202 begins running, and so forth). In situations in which the hash value for application 202 is previously generated, care is taken so that the hash value is not altered (or that alteration of the hash value can be detected) after being generated. For example, the hash value can be digitally signed by an entity trusted by device broker 206. Alternatively, the hash value for application 202 can be generated at other times, such as in response to the request from application 202 to access the desired hardware device.

Alternatively, an application identifier for application 202 can be generated in other manners. For example, an identifier can be assigned to application 202 (e.g., by a developer or distributor of application 202) and digitally signed by a trusted entity (a component, module, device, or other entity trusted by device broker 206). Device broker 206, or another component or module that is trusted by device broker 206, can verify the digital signature for application 202 to verify that the application identifier of application 202 can be trusted by device broker 206. The digital signature can be verified in response to the request from application 202 to access the desired hardware device, or at other times analogous to generation of a hash value for application 202 as discussed above.

Device permissions record 208 can be generated, and modified, at various times. In one or more embodiments, an operating system (such as operating system 102 of FIG. 1) that includes device broker 206 includes an initial device permissions record 208. Additional device interface classes and associated permission entries can be added to device permissions record 208 when new hardware is installed in the computing device implementing system 200. Device interface classes and associated permission entries can also be added, removed, and/or modified during updates to system 200. Thus, particular hardware devices and/or particular capabilities of hardware devices (and their capability identifiers) need not be known to the operating system of the computing device implementing system 200 when the computing device is created or built, but rather can be added to the computing device at a later time. Furthermore, the particular capabilities of a hardware device and their capability identifiers need not be defined to or their functionality known by the operating system of the computing device implementing system 200. Rather, the capability identifier associated with the particular capabilities can be added to device permissions record 208 and the capabilities known to application 202, which can be allowed to access those capabilities (based on device permissions record 208), in the absence of the operating system (and other components of system 200) knowing what those capabilities are.

In one or more embodiments, system 200 includes an installation manager 230 that receives or otherwise obtains device installation files and data 232. Device installation files and data 232 include one or more files and/or data that are installed on the computing device implementing system 200 as the device driver for a hardware device. Device installation files and data 232 are obtained by installation manager 230 when a new hardware device is installed on the computing device implementing system 200. For example, device installation files and data 232 can be automatically downloaded from a remote service when a new hardware device is installed on the computing device implementing system 200. Device installation files and data 232 can take a variety of different forms, such as device drivers, setup information files (e.g., INF files), metadata associated with device drivers, manifests, and so forth.

Installation manager 230 identifies permission information in device installation files and data 232 and adds that permission information to device permissions record 208. This permission information identifies changes to be made to device permissions record 208. For example, this permission information can include one or more new application identifiers to be added to (or removed from) the application ID list for a particular device interface class. By way of another example, this permission information can include one or more new device interface classes and associated permission entries to add to record 208. By way of yet another example, this permission information can include a change in type of permission (e.g., changing the consent type 216 associated with a particular device interface class from the prompt consent type to the privileged consent type, or vice versa). Analogous to the hash values for application 202 discussed above, care is taken so that the permission information in device installation files and data 232 is not altered (or that alteration of the permission information can be detected) after being generated. For example, the permission information can be digitally signed by an entity trusted by installation manager 230.

Similarly, installation manager 230 can also receive or otherwise obtain device update files and data 234. Device update files and data 234 are similar to device installation files and data 232, identifying changes to be made to device permissions record 208. However, device update files and data 234 are obtained by installation manager 230 to update device drivers and/or other data for hardware devices already installed on the computing device including system 200. Device update files and data 234 can take a variety of different forms, such as device drivers, setup information files (e.g., INF files), metadata associated with device drivers, manifests, and so forth. Device update files and data 234 can identify various permission information that installation manager 230 adds to device permissions record 208 analogous to the permission information included in device installation files and data 232. Analogous to the permission information in device installation files and data 232 discussed above, care is taken so that the permission information in device update files and data 234 is not altered (or that alteration of the permission information can be detected) after being generated. For example, the permission information can be digitally signed by an entity trusted by installation manager 230.

It should be noted that device installation files and data 232 (and/or device update files and data 234) can include different application IDs to be added to different capabilities of the same device. An application need not be given access to all capabilities of a hardware device. For example, installation and/or update data can identify one application ID to be added to the capability identifier 214 that identifies provisioning capabilities of a mobile broadband device, and another application ID to be added to the capability identifier 214 that identifies management capabilities of the mobile broadband device.

In one or more embodiments, a hardware device being installed on a computing device implementing system 200 has an associated metadata file that is an eXtensible Markup Language (XML) file, and an associated setup information file that is an INF file. Similarly, in one or more embodiments, a hardware device already installed on a computing device implementing system 200 but being updated can have an associated metadata XML file and/or INF file. The INF file indicates to installation manager 230 particular files to install and where those files are to be installed on the computing device, settings needed (e.g., in an operating system store such as an operating system registry), and so forth. The INF file also identifies particular device interface classes (e.g., using globally unique identifiers (GUIDs) or other identifiers allowing device interface classes to be distinguished from one another) for accessing capabilities of the device as well as consent types associated with each of those device interface classes. The metadata XML file includes, for each device interface class identified in the INF file having a consent type of privileged, one or more application IDs that are allowed to access the capabilities of that device interface class. It should be noted, however, that capability identifiers, consent types, and/or application ID lists can be included in device installation files and data 232 and/or device update files and data 234 in other manners rather than metadata XML and INF files.

It should also be noted that device permissions record 208 can be modified at other times and/or in response to other events. For example, a user or administrator of system 200 may provide an input indicating a particular change to make to device permissions record 208 (e.g., identifying a particular consent type to be associated with a particular capability identifier, identifying a particular application ID to be added to an application ID list associated with a particular capability identifier, etc.). Such an input can be provided by a user or administrator of system 200 accessing a configuration user interface of system 200, by a user of system 200 selecting an “allow” option when prompted for approval for the application to access the associated capabilities (e.g., in response to user selection of the “allow” option an identifier of the application can be added to the application ID list associated with a particular capability identifier), and so forth.

In one or more embodiments, device permissions record 208 is stored in a secure manner that restricts which components or modules are permitted to update record 208. For example, device permissions record 208 can be stored in protected memory that can be modified only by particular components or modules (e.g., one or modules of installation manager 230, or only modules of an operating system that includes device broker 206), optionally only at particular times (e.g., during a process of booting a computing device including system 200) such as using a variety of conventional trusted boot or secure boot techniques. By way of another example, device permissions record 208 can be digitally signed (e.g., by installation manager 230 or another entity trusted by device broker 206) and used by device broker 206 only if the digital signature on record 208 is verified.

Device permissions record 208 is illustrated in FIG. 2 as a table including multiple capability identifiers and associated consent types and/or application ID lists. Although illustrated as a table, it should be noted that device permissions record 208 can be implemented using a variety of different data structures or storage techniques. It should also be noted that device permissions record 208 can be separated into multiple stores or tables. For example, device permissions record 208 could have two stores, one store including capability identifiers 214 and associated consent types 216, and the other store including capability identifiers 214 and associated application ID lists 218.

Additionally, it should be noted that the list of hardware devices known to the computing device implementing system 200 need not be (although alternatively can be) static. As hardware devices are added to the computing device implementing system 200, device permissions record 208 is managed to appropriately reflect how types of consent are to be applied to new instances of hardware devices added to the computing device implementing system 200 upon subsequent requests for access by application 202. New instances of hardware devices refer to hardware devices having capabilities for which capability identifiers 214 are already included in device permissions record 208. For example, one particular camera (one instance of a camera) can already be coupled to the computing device implementing system 200, and a second camera (a new instance of a camera) can be installed on the computing device. Capability identifiers 214 for capabilities of the camera can already be included in device permissions record 208, even though this second camera is a new camera installed on the computing device.

In one or more embodiments, device broker 206 applies one or more of various policies or rules for new instances of hardware devices installed on the computing device implementing system 200. For example, device broker 206 can determine that the type of consent identified by a particular capability identifier 214 in device permissions record 208 is applicable to all applications requesting to access the class of capabilities identified by that particular capability identifier 214 regardless of when the hardware device was installed. By way of another example, device broker 206 can determine that access to the class of capabilities identified by a particular capability identifier 214 for new instances of hardware devices are denied until appropriate consent is acquired from the user (e.g., the user is prompted for approval for the new instance of the hardware device to be accessed, or is prompted for approval for the new instance of the hardware device to be treated in the same manner as other instances of the hardware device already installed on the computing device). Alternatively, more granular determinations of how consent should be applied to new instances of hardware devices can be made (e.g., based on the specific capability identifier 214 or the specific consent type 216 associated with the capability identifier 214 for which access is being requested).

Furthermore, in one or more embodiments particular applications are restricted to accessing capabilities of particular hardware devices. Such restrictions allow, for example, a particular vendor (e.g., manufacturer, distributor, etc.) to restrict which applications can access capabilities of that vendor's hardware devices (regardless of whether other hardware devices from other vendors support the same capabilities). Such restrictions can be implemented in different manners. For example, different capability identifiers 214 can be used for different hardware devices (even though the capabilities identified by those different capability identifiers may be the same). By way of another example, data associated with a hardware device (e.g., data initially included in an operating system, data in device installation files and data 232, data in device update files and data 234, etc.) can include indications of particular hardware devices (e.g., identified by hardware device vendor, hardware device model, etc.) that can be accessed by applications having particular application IDs. The indications of these hardware devices can be maintained, such as by associating the indications of these hardware devices with particular application IDs in device permissions record 208. Following this example, device broker 206 can allow application 202 to access a class of capability of a particular hardware device only if an application ID of application 202 is included in the application ID list 218 associated with that class of capability and if that particular hardware device is associated with the application ID of application 202 in the application ID list 218 for that class of capability.

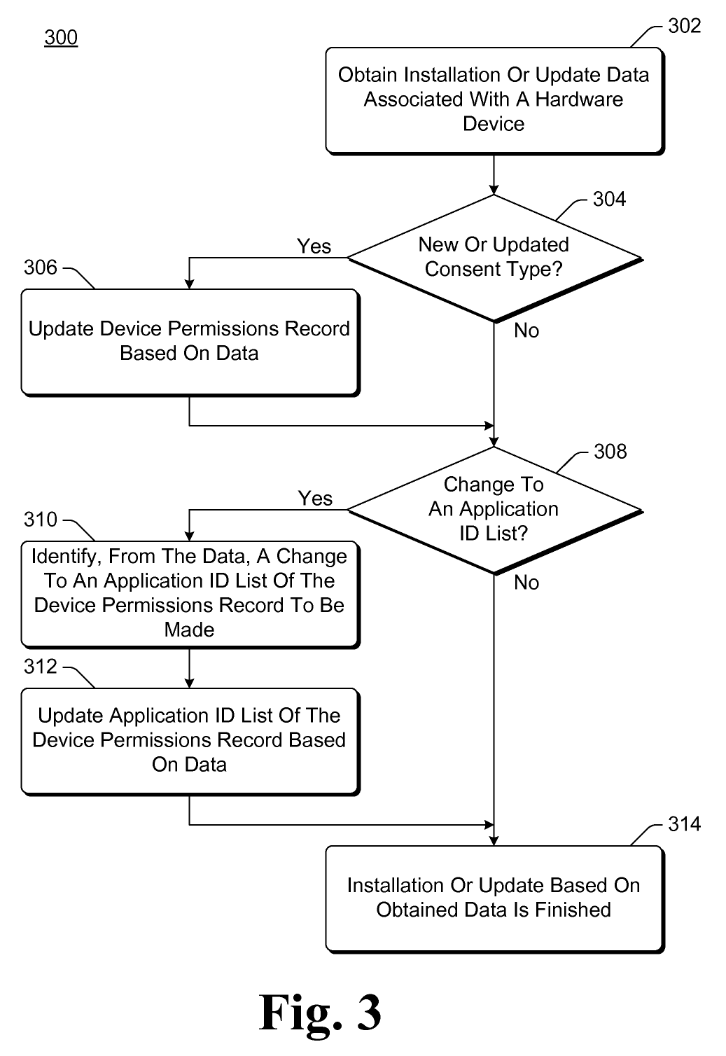

FIG. 3 is a flowchart illustrating an example process 300 for changing a device permissions record in accordance with one or more embodiments. Process 300 is carried out by a computing device, such as computing device 100 of FIG. 1, and can be implemented in software, firmware, hardware, or combinations thereof. Process 300 is shown as a set of acts and is not limited to the order shown for performing the operations of the various acts. Process 300 is an example process for changing a device permissions record; additional discussions of changing a device permissions record are included herein with reference to different figures.

In process 300, installation or update data associated with a hardware device is obtained (act 302). This data is used during installation of a hardware device on a computing device, and/or during updating of device drivers and/or other data for hardware devices already installed on the computing device. The data can be, for example, from device installation files and data 232 and/or device update files and data 234 of FIG. 2.

A check is made as to whether the installation or update data includes a new or updated consent type (act 304). A new consent type refers to a consent type for a capability of a new hardware device being installed on the computing device, as well as a consent type for a new capability of a hardware device already installed on the computing device. An updated consent type refers to a change in consent type for a capability of a hardware device already installed on the computing device.

If the installation or update data includes a new or updated consent type, then the device permissions record is updated based on the obtained installation or update data (act 306). This updating of the device permissions record includes various changes to the device permissions record, such as adding a new consent type to the device permissions record, changing the consent type for a capability of a hardware device already installed on the computing device, and so forth.

Additionally, a check is also made as to whether the installation or update data includes a change to an application ID list (act 308). A change to an application ID list refers to a change to (e.g., addition of, deletion of, etc.) identifiers of one or more applications that are to be allowed to access a capability of a hardware device that is being installed on or is already installed on the computing device. A change to an application ID list can be included in the installation or update data for capabilities associated with a privileged consent type, as discussed above.

A change to an application ID list of the device permissions record to be made is identified from the installation or update data (act 310). This identification can be identifying an identifier of an application that is allowed to access a particular capability of a hardware device, or identifying an identifier of an application that is not allowed to access a particular capability of a hardware device.

The application ID list of the device permissions record is updated based on the obtained installation or update data (act 312). This updating in act 312 can include storing an identifier of an application in the device permissions record as being allowed to access a particular capability of a hardware device without further user consent (e.g., adding the identifier to an application ID list associated with the particular capability), removing an identifier of an application from the device permissions record so that the application is not allowed to access a particular capability of a hardware device (e.g., removing the identifier from an application ID list associated with the particular capability), and so forth.

After the device permissions record is updated to reflect any new or updated consent types based on the installation or update data, and/or is updated to reflect any changes to an identifier of an application, the installation or update based on the data obtained in act 302 is finished (act 314). Additional installation or update data can be obtained at a later time, and process 300 can be repeated, resulting in additional changes to the device permissions record being made based on the additional installation or update data.

Alternatively, in situations in which the installation or update data obtained in act 302 is installation data for a new instance of a hardware device, acts 304-314 can be performed only after appropriate consent is received from the user. Thus, no changes to a consent type of the device permissions record and no changes to an application ID list of the device permissions record are made based on the installation for the new instance of a hardware device until such changes are approved by the user.

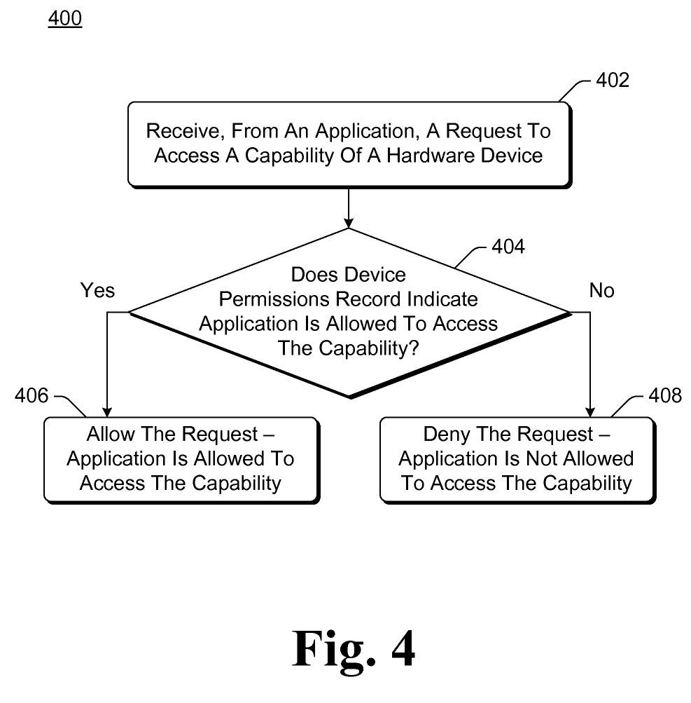

FIG. 4 is a flowchart illustrating an example process 400 for responding to requests to access a capability of a hardware device in accordance with one or more embodiments. Process 400 is carried out by a computing device, such as computing device 100 of FIG. 1, and can be implemented in software, firmware, hardware, or combinations thereof. Process 400 is shown as a set of acts and is not limited to the order shown for performing the operations of the various acts. Process 400 is an example process for responding to requests to access a capability of a hardware device; additional discussions of responding to requests to access a capability of a hardware device are included herein with reference to different figures.

In process 400, a request to access a capability of a hardware device is received (act 402). This request is received at a device broker as discussed above.

A check is made as to whether a device permissions record indicates that the application is allowed to access the capability (act 404). This check is made, for example, by checking whether a consent type associated with the capability is a privileged consent type, and if so whether an identifier of the application is included in an application ID list associated with the capability of the hardware device. This check is typically made in a trusted part of an operating system of the computing device implementing process 400 to protect against the application tampering with or otherwise interfering with the check, as discussed above.

If, based on the check in act 404, it is determined that the application is allowed to access the capability, then the request is allowed and the application is allowed to access the capability (act 406). This allowing can be, for example, returning a handle to or other identifier of the requested capability to the application as discussed above. However, if based on the check in act 404 it is determined that the application is not allowed to access the capability, then the request is denied and the application is not allowed to access the capability (act 408). This denying can be, for example, refusing to return a handle to or other identifier of the capabilities to the application as discussed above.

Thus, the binding applications to device capabilities techniques discussed herein allow different capabilities of hardware devices to be accessible to only particular applications. For example, a printer vendor can distribute applications that manage the printers that they distribute, allowing only the applications for printer management that they develop or otherwise approve of (and optionally that other printer vendors develop or otherwise approve of) to manage the printers but allow all applications to print data using the printers. By way of another example, a vendor can develop a new hardware device and an application that uses that hardware device, and allow only the application that the vendor develops to use that hardware device.

Furthermore, systems using the binding applications to device capabilities techniques discussed herein are extensible. Which applications are allowed to access hardware devices can change over time. Additionally, new hardware devices (e.g., having one or more new device interface classes) can be installed on systems with only the applications that the hardware device developer or vendor desires to be able to access the hardware devices being able to access the hardware devices.

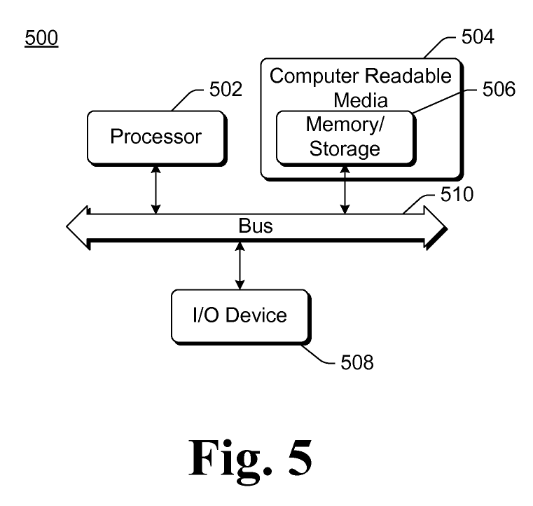

FIG. 5 illustrates an example computing device 500 that can be configured to implement the binding applications to device capabilities in accordance with one or more embodiments. Computing device 500 can be, for example, computing device 100 of FIG. 1 and/or can implement system 200 of FIG. 2.

Computing device 500 includes one or more processors or processing units 502, one or more computer readable media 504 which can include one or more memory and/or storage components 506, one or more input/output (I/O) devices 508, and a bus 510 that allows the various components and devices to communicate with one another. Computer readable media 504 and/or one or more I/O devices 508 can be included as part of, or alternatively may be coupled to, computing device 500. Bus 510 represents one or more of several types of bus structures, including a memory bus or memory controller, a peripheral bus, an accelerated graphics port, a processor or local bus, and so forth using a variety of different bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 502. It is to be appreciated that different instructions can be stored in different components of computing device 500, such as in a processing unit 502, in various cache memories of a processing unit 502, in other cache memories of device 500 (not shown), on other computer readable media, and so forth. Additionally, it is to be appreciated that the location where instructions are stored in computing device 500 can change over time.

One or more input/output devices 508 allow a user to enter commands and information to computing device 500, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, applications, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 5. The features of the binding applications to device capabilities techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method in a computing device, the method comprising:
receiving, from an application, a request to access a capability of a hardware device installed on the computing device;
checking, by the computing device, whether the application is identified in a device permissions record as being allowed to access the capability of the hardware device; and
allowing the application to access the capability of the hardware device if the device permissions record indicates the application is allowed to access the capability of the hardware device, otherwise denying the request.

2. A method as recited in claim 1, wherein the checking comprises obtaining an identifier of the application and checking whether the identifier of the application is included in the device permissions record as associated with the capability of the hardware device.

3. A method as recited in claim 2, wherein the identifier of the application comprises a hash value generated by applying a cryptographic hash function to metadata of the application, the hash value being digitally signed by an entity trusted by a module of the computing device performing the checking.

4. A method as recited in claim 1, wherein the request comprises a request to access a device interface class that identifies the capability of the hardware device.

5. A method as recited in claim 4, wherein the device permissions record includes a list of one or more application identifiers that are allowed to access the device interface class, and wherein checking whether the application is identified in the device permissions record comprises checking whether an identifier of the application is included in the list of one or more application identifiers.

6. A method as recited in claim 1, wherein the device permissions record includes a list of one or more application identifiers that are allowed to access the capability of the hardware device, the method further comprising adding one or more new application identifiers to the list of one or more application identifiers during installation on the computing device of a new hardware device.

7. A method as recited in claim 1, the request comprising a request to access a hardware device from a particular vendor, the allowing comprising allowing the application to access the capability of the hardware device only if the device permissions record indicates the application is allowed to access the capability of the hardware device from the particular vendor.

8. A method as recited in claim 1, wherein the device permissions record includes multiple capability identifiers that need not be defined to an operating system of the computing device and, for each of the multiple capability identifiers an associated list of one or more application identifiers that are allowed to access the capability identified by the capability identifier, the method further comprising adding, during installation on the computing device of a new hardware device, an additional capability identifier and an additional list of one or more identifiers that is associated with the additional capability identifier.

9. A method as recited in claim 8, wherein each of the multiple capability identifiers comprises a device interface class.

10. A method as recited in claim 8, wherein each of the multiple capability identifiers comprises a hardware instance identifier.

11. A method as recited in claim 8, wherein each of the multiple capability identifiers comprises a model identifier.

12. A method in a computing device, the method comprising:
obtaining installation data associated with a hardware device;
identifying, from the installation data, an identifier of an application that is allowed to access a first capability of the hardware device; and
storing the identifier of the application in a device permissions record as being allowed to access, without further user consent, the first capability of the hardware device.

13. A method as recited in claim 12, further comprising performing the identifying and storing during installation of the hardware device on the computing device.

14. A method as recited in claim 12, further comprising:
obtaining update data associated with the hardware device;
identifying, from the update data, an identifier of an additional application that is allowed to access the first capability of the hardware device; and
storing the identifier of the additional application in the device permissions record as being allowed to access the first capability of the hardware device.

15. A method as recited in claim 12, wherein the device permissions record includes multiple capability identifiers and, for each of the multiple capability identifiers an associated list of one or more application identifiers that are allowed to access the capability identified by the capability identifier, wherein the first capability of the hardware device is identified by one of the multiple capability identifiers, and wherein storing the identifier of the application includes adding the application identifier to the list of one or more application identifiers associated with the capability identifier that identifies the first capability of the hardware device.

16. A method as recited in claim 12, the first capability of the hardware device being associated with a consent type indicating that access to the first capability of the hardware device is allowed only to privileged applications identified in a list of application identifiers, and a second capability of the hardware device being associated with a consent type indicating that access to the second capability of the hardware device is allowed regardless of which application is requesting access to the second capability of the hardware device.

17. A method as recited in claim 12, wherein the device permissions record includes multiple capability identifiers and, for each of the multiple capability identifiers an associated list of one or more application identifiers that are allowed to access the capability identified by the capability identifier, and wherein storing the identifier of the application comprises adding, to the multiple capability identifiers, a new capability identifier that identifies the first capability of the hardware device, and adding a new list of one or more application identifiers associated with the new capability identifier.

18. A method as recited in claim 12, further comprising:
receiving, from the application, a request to access the first capability of the hardware device;
checking, by a trusted component of the computing device, whether the application is identified in the device permissions record as being allowed to access the first capability of the hardware device; and
allowing the application to access the first capability of the hardware device due to the device permissions record indicating that the application is allowed to access the first capability of the hardware device.

19. A method as recited in claim 12, further comprising:
receiving, from an additional application, a request to access the first capability of the hardware device;
checking whether the additional application is identified in the device permissions record as being allowed to access the first capability of the hardware device; and
allowing the additional application to access the first capability of the hardware device if the device permissions record indicates that the application is allowed to access the first capability of the hardware device, otherwise denying the request.

20. A method in a computing device, the method comprising:
obtaining installation data associated with a hardware device, the hardware device being of a particular hardware device type;
identifying, from the installation data, both a device interface class that identifies a particular collection of capabilities of the particular hardware device type and an identifier of each of one or more applications that are allowed to access the particular collection of capabilities;
storing the identifier of each of the one or more applications in a device permissions record as being associated with an identifier of the device interface class;
receiving, from an application, a request to open a handle to the device interface class;
checking, by the computing device, whether an identifier of the application is an identifier stored in the device permissions record as being associated with the identifier of the device interface class; and
returning the handle to the application if the identifier of the application is an identifier stored in the device permission record as being associated with the identifier of the device interface class, otherwise denying the request.
